(19) United States
(12) Patent Application Publication
(10) Pub. No.: US 2018/0346800 A1
(43) Pub. Date: Dec. 6, 2018

(54) Sealers for Use in Stimulating Wells

(71) Applicant: BJ Services, LLC, Tomball, TX (US)

(72) Inventors: Diankui Fu, Houston, TX (US); Angel F. Gonzalez, Katy, TX (US); Leonid Vigderman, Baytown, TX (US); Lingjuan Shen, Tomball, TX (US)

(73) Assignee: BJ Services, LLC, Tomball, TX (US)

(21) Appl. No.: 15/992,882

(22) Filed: May 30, 2018

Related U.S. Application Data
(60) Provisional application No. 62/514,975, filed on Jun. 5, 2017.

(51) Int. Cl. C09K 8/80; C09K 8/588; C09K 8/92; E21B 33/138; E21B 43/267

(52) U.S. Cl. CPC C09K 8/80; C09K 8/588; E21B 43/267; E21B 33/138; C09K 8/92

(57) ABSTRACT

Sealers are used to selectively divert flow through liner openings during stimulation operations. The sealers comprise an aggregate of dissolvable particles that will allow the sealer to dissolve more quickly once the stimulation operation is finished. The aggregate preferably comprises a distribution of different particle sizes. Larger particles will provide the primary bridge across the opening, with smaller sizes filling gaps between the larger particles and allowing the aggregate to more effectively plug the opening.

### FIELD OF THE INVENTION

The present invention relates to introducing fluids into oil and gas bearing formations so that production of hydrocarbons from a well is enhanced, and more particularly, to sealers for sealing openings in liners and methods of stimulating formations with the sealers.

### BACKGROUND OF THE INVENTION

Hydrocarbons, such as oil and gas, may be recovered from various types of subsurface geological formations. The formations typically consist of a porous layer, such as limestone and sands, overlaid by a nonporous layer. Hydrocarbons cannot rise through the nonporous layer, and thus, the porous layer forms a reservoir, that is, a volume in which hydrocarbons accumulate. A well is drilled through the earth until the hydrocarbon bearing formation is reached. Hydrocarbons then are able to flow from the porous formation into the well.

A modern oil well typically includes a number of tubes extending wholly or partially within other tubes. That is, a well is first drilled to a certain depth. Larger diameter pipes, or casings, are placed in the well and cemented in place to prevent the sides of the borehole from caving in. After the initial section has been drilled, cased, and cemented, drilling will proceed with a somewhat smaller well bore. The smaller bore is lined with somewhat smaller pipes or “liners.” The liner is suspended from the original or “host” casing by an anchor or “hanger.” A well may include a series of smaller liners, and may extend for many thousands of feet, commonly up to and over 25,000 feet.

Many oil and gas bearing geological formations, such as sandstone, are very porous. Hydrocarbons are able to flow easily from the formation into a well. Other formations, however, such as shale, limestone, and coal beds, are only minimally porous. The formation may contain large quantities of hydrocarbons, but production through a conventional well may not be commercially practical because hydrocarbons flow though the formation and collect in the well at very low rates. The industry, therefore, relies on various techniques for improving the well and stimulating production from formations.

In general, such techniques share the dual goals of (a) increasing the surface area of the formation exposed to the well, and (b) increasing the conductivity of fluids through the formation. That is, they increase the number and size of hydrocarbon flow paths through the formation and enhance the ability of fluid to flow easily through the flow paths. They may be applied to relatively porous formations, but are critical for economic recovery of hydrocarbons from minimally porous formations such as shale and other so-called “unconventional” formations.

Perhaps the most important stimulation technique is the combination of horizontal well bores and hydraulic fracturing. A well will be drilled vertically until it approaches a formation. It then will be diverted, and drilled in a more or less horizontal direction, so that the borehole extends along the formation instead of passing through it. More of the formation is exposed to the borehole, and the average distance hydrocarbons must flow to reach the well is decreased. Fractures then are created in the formation that will allow hydrocarbons to flow more easily from the formation.

Fracturing a formation is accomplished by pumping fluid into the well at high pressure and flow rates. Fluid is forced into the formation at rates faster than can be accepted by the existing pores, fractures, faults, vugs, caverns, or other spaces within the formation. Pressure builds rapidly to the point where the formation fails and begins to fracture. Continued pumping of fluid into the formation will tend to cause the initial fractures to widen and extend further away from the well bore.

At a certain point, the initial “pad” of fluid will create and enlarge fractures to the point where proppants are added to the fluid. Proppants are solid particulates, such as grains of sand, that are carried into fractures by the fluid. They serve to prevent the fractures from closing after pumping is stopped. The proppant typically will be added in increasing concentration as the formation continues to accept fluid and fracturing continues. In shale formations, for example, fractures may extend 150 to 300 feet away from the well bore.

In any event, when the desired degree of fracturing has been achieved, pumping is stopped, and the well is “shut in.” That is, valves at the surface are closed, and fluid is held in the well. As the well is shut in, the formation begins to relax, and fractures tend to close on the entrained proppant. Depending on the formation and the operation, the well may be shut in for a few minutes or hours. Eventually the surface valves will be opened to allow the fluid to “clean out” of the fractures. That is, fluid will flow out of the formation, leaving proppant packed fractures that will provide additional flow paths for produced hydrocarbons. As flowback of injected fluids continues, hydrocarbons begin to flow from the formation, into the well, and ultimately to the surface.

The liner passing through the hydrocarbon bearing formation is referred to as the production liner and will be used to perform the fracturing operation or “frac” job. The production liner commonly incorporates an “initiator” or “toe” valve at the end which can be actuated to open ports in the valve. The liner also may incorporate a series of frac valves, typically ball-drop, sliding sleeve valves, which are arrayed along the length of the liner. The frac valves will be actuated by pumping a ball or other plug into the valve. The ball will actuate the sleeve to open ports in the valve. The ball restricts flow through the valve and diverts it through the ports and into the formation. Once fracturing is complete various operations will be performed to “unplug” the valve and allow fluids from the formation to enter the liner and travel to the surface.

In many wells, however, the production liner does not incorporate frac valves. Instead, fracturing will be accomplished by “plugging and perfing” the liner. In a “plug and perf” job, the production liner is made up from standard lengths of liner. The liner usually will incorporate a toe valve near its end, but otherwise does not have any openings through its sidewalls, nor does it incorporate frac valves. It is installed in the well bore, and holes then are punched in the liner walls. The perforations typically are created by so-called “perf” guns that discharge shaped charges through the liner and, if present, adjacent cement.

A formation rarely will be fractured all at once. It typically will be fractured at many different locations and in many different stages. For example, the toe valve will be opened, usually by increasing hydraulic fluid in the liner. Fluids then are pumped into the well to fracture the formation in an initial zone in the vicinity of the toe valve. After the initial zone is fractured, a plug is installed in the liner at a point above the toe valve and the first fractured zone. The liner is perforated above the plug, typically at several locations. A ball then is deployed onto the plug. The ball will restrict fluids from flowing through and past the plug. When fluids are injected into the liner, therefore, they will be forced to flow out the perforations and into the second zone. After the second zone is fractured, additional plugs are installed, and the process is repeated until all zones in the well are fractured.

The fluids, pumping rates and quantities, distribution of perforations (or valves), and layout of zones for a particular fracturing operation will be determined in view of the physical properties of the formation that will be fractured and depth at which it is located. Unfortunately, it is not always easy to accurately assess the formation. The formation in a particular zone, while rarely homogeneous, may not be acceptably heterogeneous. Portions of the formation may be more easily fractured than other portions.

For example, a liner may have three sets of perforations spaced through a particular zone. The number of sets would have been selected, at least in part, based on the expectation that the formation surrounding each set of perforations had similar physical properties. In other words, the assumption would have been that fracturing of the formation adjacent each set of perforations would proceed at substantially the same rate and to substantially the same extent.

That assumption, however, is not always proven out in practice. The formation may be much harder in one area than another. The flow of frac fluid is always preferentially into the path of least resistance. Thus, once fracturing is initiated, the formation may fracture extensively around one set of perforations, but not so much around another set of perforations. Production fluids, therefore, may be able to flow easily from one part of the zone and may not flow in any significant quantities from another part of the zone.

One way of managing situations where there is uneven fracturing through a zone is to deploy what are referred to as “perforation balls” or “ball sealers.” As their name implies, ball sealers most commonly are relatively small, spherically shaped balls. A quantity of ball sealers may be pumped into a liner along with frac fluids. The ball sealers will flow preferentially toward the perforations that lead to the portions of the formation offering the least resistance, that is, the portions that already have experienced extensive fracturing. The ball sealers will be fashioned and sized to lodge or seat against perforations and block flow through the perforations.

When the perforations adjacent the most heavily fractured part of the formation have been plugged with ball sealers, frac fluids will begin to flow preferentially through the perforations leading to the parts of the formation offering the next lowest resistance—the portion with somewhat less fracturing. Pumping will continue for a period of time and another batch of ball sealers is pumped into the well to plug those perforations. The process is repeated until the formation adjacent all perforations in the zone have been adequately fractured.

A wide variety of ball sealers are known in the art and are commercially available. Perhaps the most typical conventional ball sealers are hard, solid spheres made of polyamides, phenolics, syntactic foam, or aluminum that are capable of resisting extrusion through an opening. Many have a rubber coating that provides protection from solvents and aids in forming a seal. A sealer comprising a deformable rubber bladder filled with nondeformable particulates such a nylon beads is disclosed in U.S. Pat. No. 5,253,709 to L. Kendrick et al. Ball sealers also may incorporate microspheres or other fillers to provide different physical or chemical properties, such as varying densities.

Degradable ball sealers typically are made from polymers such as polyvinyl alcohol, polyvinyl acetate, and blends of polyethylene oxide, poly(propylene oxide), and polylactic acid. Degradable ball sealers made from soluble filler materials, such as glycerin, wintergreen oil, oxyzolidine, oil, and water, and a collagen adhesive are disclosed in U.S. Pat. No. 6,380,138 to N. Ischy et al. U.S. Pat. Publ. 2012/0214715 of H. Luo et al. discloses degradable balls made from carboxylic acids, fatty alcohols, fatty acid salts, or esters.

Multi-layer ball sealers are disclosed in U.S. Pat. No. 8,714,250 to B. Baser et al. The ball sealers can have a nondeformable core, a deformable intermediate layer, and a water soluble or hydrolysable outer layer. Alternately, they may have non-deformable inner layers and a water soluble or hydrolysable, deformable outer layer.

There are various challenges, however, in successfully utilizing ball sealers to balance out the extent of fracturing across a zone. First, perforations in a liner may not be uniform, either as formed or after years of exposure to well fluids. Perforation openings may be elongated due to the casing curvature and the angle at which the perforation gun was discharged. Perforations also may have been formed with burrs or uneven surfaces, or they may corrode or accumulate scale. Thus, it may be difficult to shut off flow through perforations in a well with any given size or configuration of ball sealer. Various solutions to such issues have been proposed, such as the use of sealing agents as disclosed in U.S. Pat. Publ. 2011/0226479 of P. Tippel et al.

In addition, once lodged or seated against a perforation, a ball sealer may become stuck and remain in the perforation after the flow of fluids into the liner is stopped. The flow rates and pressures out of the formation may not be sufficient to dislodge the balls. Various hydraulic or mechanical sweeps through the liner may be necessary to dislodge the sealers. Dissolvable sealers have been proposed to eliminate the need of a sweep. Conventional dissolvable sealers, however, may take a relatively long time to dissolve, and therefore, can impede production from a well for significant periods of time. Thus, the use of ball sealers remains problematic.

The statements in this section are intended to provide background information related to the invention disclosed and claimed herein. Such information may or may not constitute prior art. It will be appreciated from the foregoing, however, that there remains a need for new and improved ball sealers and methods of using ball sealers to aid in stimulating production from oil and gas wells. Such disadvantages and others inherent in the prior art are addressed by various aspects and embodiments of the subject invention.

### SUMMARY OF THE INVENTION

The subject invention, in its various aspects and embodiments, is related generally to stimulating production from a well by injecting various fluids into a hydrocarbon bearing formation. Thus, one aspect of the invention provides novel sealers which may be used to shut off flow through perforations or other liner openings to allow stimulation of the well through other openings.

Embodiments of the novel sealers comprise an aggregate of dissolvable particles. The aggregate preferably comprises a distribution of different particle sizes that will allow the aggregate to effectively seal liner openings, but will dissolve more quickly once the stimulation operation is finished. Larger particles will provide the primary bridge across the opening, with smaller sizes filling gaps between the larger particles and allowing the aggregate to more effectively plug the opening.

Other embodiments provide sealers where the dissolvable particles in the aggregate comprise particles of a first particle size and a distribution of second, smaller particle sizes or where the dissolvable particles comprise at least three different sizes.

Still other embodiments provide sealers where the particle sizes include large particles having a diameter of at least about 20% of a target liner opening size or diameters from about 1 to about 3 mm in diameter.

Additional embodiments provide sealers where the particles comprise smaller particles having a diameter of from about 30 to 40% of the diameter of the large particles or where the smaller particles have a diameter of from about 30 to 40% of the large particles or less.

In yet other embodiments the particles are composed of a dissolvable polymer.

Other embodiments provide sealers where a matrix is used to facilitate packaging of the aggregate in a film. Still other embodiments employ a matrix which will provide the sealer with physical integrity so that it may be packaged, shipped, and deployed.

Further embodiments provide sealers where the aggregate comprises a matrix agglomerating the dissolvable particles. In other embodiments the matrix is dissolvable or is a dissolvable polymer.

Yet other embodiments provide sealers where the matrix allows for deformation of the aggregate or provides structural integrity for the aggregate.

Additional embodiments provide sealers where the aggregate is encapsulated in a dissolvable film or where the dissolvable film is composed of a dissolvable polymer.

Other embodiments include particles and aggregates having additives, both chemical and physical, for controlling the dissolution rate of the primary component of the particle. Still other embodiments include non-dissolvable particles that may be incorporated to provide additional properties, such as increased strength, or to control the specific gravity and the buoyancy of the sealers.

In other aspects and embodiments, the subject invention provides methods of selectively diverting well fluids through a plurality of openings in a liner during a stimulation operation. The method comprises pumping fluid into the liner. A batch of sealers are deployed into the fluid in a quantity sufficient to plug a subset of the liner openings. The sealers then are flowed into the subset of liner openings, allowing them to plug the subset of openings and diverting flow through unplugged openings in the liner. The sealers comprise an aggregate of dissolvable particles. Preferably, the sealers have an aggregate comprise dissolvable particles having a distribution of sizes.

Other embodiments provide methods where the dissolvable particles in the aggregate comprise particles of a first particle size and a distribution of second, smaller particle sizes or where the dissolvable particles comprise at least three different sizes.

Still other embodiments provide methods where the particle sizes include large particles having a diameter of at least about 20% of a target liner opening size or a diameter from about 1 to about 3 mm in diameter.

Additional embodiments provide methods where the particles comprise smaller particles having a diameter of from about 30 to 40% of the diameter of the large particles or where the smaller particles have a diameter of from about 30 to 40% of the large particles or less.

In yet other embodiments the particles are composed of a dissolvable polymer.

Other embodiments provide methods where the aggregate comprises a matrix agglomerating the dissolvable particles. In other embodiments the matrix is dissolvable or is a dissolvable polymer.

Yet other embodiments provide methods where the matrix allows for deformation of the aggregate or provides structural integrity for the aggregate.

Additional embodiments provide methods where the aggregate is encapsulated in a dissolvable film or where the dissolvable film is composed of a dissolvable polymer.

Other embodiments include methods where the particles and aggregates have additives, both chemical and physical, for controlling the dissolution rate of the primary component of the particle. Still other embodiments include non-dissolvable particles that may be incorporated to provide additional properties, such as increased strength, or to control the specific gravity and the buoyancy of the sealers.

Finally, still other aspect and embodiments of the invention will have various combinations of such features as will be apparent to workers in the art.

Thus, the present invention in its various aspects and embodiments comprises a combination of features and characteristics that are directed to overcoming various shortcomings of the prior art. The various features and characteristics described above, as well as other features and characteristics, will be readily apparent to those skilled in the art upon reading the following detailed description of the preferred embodiments and by reference to the appended drawings.

Since the description and drawings that follow are directed to particular embodiments, however, they shall not be understood as limiting the scope of the invention. They are included to provide a better understanding of the invention and the manner in which it may be practiced. The subject invention encompasses other embodiments consistent with the claims set forth herein.

### BRIEF DESCRIPTION OF THE DRAWINGS

FIG. 1A (prior art) is a schematic illustration of an early stage of a “plug and perf” fracturing operation showing a tool string 15 deployed into a liner assembly 6, where tool string 15 includes a perf gun 17, a setting tool 18, and a frac plug 19a.

FIG. 1B (prior art) is a schematic illustration of line assembly 6 after completion of the plug and perf fracturing operation, but before removal of plugs 19 from liner 6.

FIG. 2 (prior art) is a schematic illustration of a fractured zone along a portion of liner assembly 6 shown in FIG. 1.

FIG. 3 is a schematic illustration of a first preferred embodiment 30 of the novel sealers of the subject invention.

FIG. 4 is a schematic illustration of a second preferred embodiment 130 of the novel sealers of the subject invention.

In the drawings and description that follows, like parts are identified by the same reference numerals. The drawing figures are not necessarily to scale. Certain features of the invention may be shown exaggerated in scale or in somewhat schematic form and some details of conventional design and construction may not be shown in the interest of clarity and conciseness.

### DESCRIPTION OF ILLUSTRATIVE EMBODIMENTS

The subject invention relates to stimulating production from a well by injecting various fluids into a hydrocarbon bearing formation. Thus, various embodiments provide methods for controlling flow into a formation through, inter alia, the use of novel sealers. There are many conventional stimulation processes, such as acidizing or water flooding, but one of the most important ways of stimulating production from wells is to fracture the formation as discussed above.

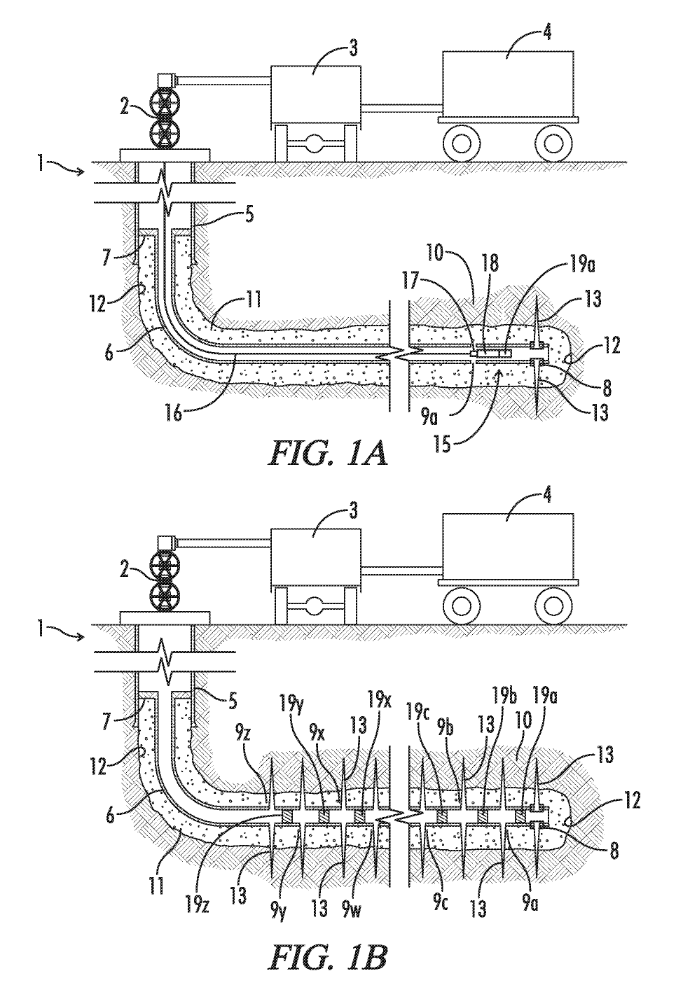

FIG. 1, therefore, illustrate schematically a “plug and perf” operation for fracturing a well. As shown therein, well 1 is serviced by a well head 2, pumps 3, mixing/blending units 4, and various surface equipment (not shown). Mixing/blending units 4 will be used to prepare the fluids used to fracture well 1. Pumps 3 will be used to introduce the fracturing fluids into well 1 at high pressures and flow rates. Other surface equipment will be used to introduce tools into well 1 and to facilitate other completion and production operations.

The upper portion of well 1 is provided with a casing 5 that extends to the surface. A production liner 6 has been installed in the lower portion of casing 5 via a liner hanger 7. It will be noted that the lower part of well 1 and liner 6 extend generally horizontally through a hydrocarbon bearing formation 10. Liner 6, as installed in well 1, is not provided with valves or any openings in the walls thereof other than a toe valve 8. Liner 6 also has been cemented in place. That is, cement 11 has been introduced into the annular space between liner 6 and the well bore 12.

A typical frac job will proceed in stages from the lowermost zone in a well to the uppermost zone. Thus, FIG. 1A shows well 1 after the initial stage of a frac job has been completed. Toe valve 8 was closed when liner 6 was run in and installed, but it now has been opened. Fluid has been introduced into formation 10 via ports in open toe valve 8, and fractures 13 extending from toe valve 8 have been created in a first zone near the bottom of well 1.

A tool string 15 has been run into liner 6 on a wireline 16. Tool string 15 comprises a perf gun 17, a setting tool 18, and a frac plug 19a. Tool string 15 is positioned in liner 6 such that frac plug 19a is uphole from toe valve 8. Frac plug 19a is coupled to setting tool 18 and will be installed in liner 6 by actuating setting tool 18 via wireline 16. Once plug 19a has been installed, setting tool 18 will be released from plug 19a. Perf gun 17 then will be fired to create perforations 9a in liner 6 uphole from plug 19a. Perf gun 17 and setting tool 18 then will be pulled out of well 1 by wireline 16.

A frac ball (not shown) then will be deployed onto plug 19a to restrict the downward flow of fluids through plug 19a. Plug 19a, therefore, will substantially isolate the lower portion of well 1 and the first fractures 13 extending from toe valve 8. Fluid then can be pumped into liner 6 and forced out through perforations 9a to create fractures 13 in a second zone. After fractures 13 have been sufficiently developed, pumping is stopped and valves in well head 2 will be closed to shut in well 1. After a period of time, fluid will be allowed to flow out of fractures 13, through liner 6 and casing 5, to the surface.

Additional plugs 19b to 19z then will be run into well 1 and set, liner 6 will be perforated at perforations 9b to 9z, and well 1 will be fractured in succession as described above until, as shown in FIG. 1B, all stages of the frac job have been completed and fractures 13 have been established in all zones. Once the fracturing operation has been completed, plugs 19 typically will be drilled out and removed from liner 6. Production equipment then will be installed in the well and at the surface to control production from well 1.

It will be noted that the methods and systems for fracturing operations, and for producing hydrocarbons, are complex and varied. Moreover, FIG. 1 are greatly simplified schematic representations of a plug and perf fracturing operation. The fluid delivery system has been greatly simplified. For example, a single pump 3 is depicted whereas in practice many pumps, perhaps 20 or more, may be used. Many different blenders, mixers, manifolding units, and the like may be used but are not illustrated. Production liner 6 also is shown only in part as such liners may extend for a substantial distance. The portion of liner 6 not shown also will be provided with perforations 9 and plugs 19, and fractures 13 will be established in the formation 10 adjacent thereto. In addition, FIG. 1 depict only a few perforations 9 in each zone, whereas typically a zone will be provided with many perforations. Likewise, a well may be fractured in any number of zones, thus liner 6 may be provided with more or fewer plugs 19 than depicted. It is believed the novel sealers may be used in the context of many known systems and methods for stimulating and producing hydrocarbons from a well. An appropriate system and method may be selected with routine effort by workers in the art. Nevertheless, it is believed the methods and systems described herein will provide an understanding of the broader context in which the novel sealers may be used.

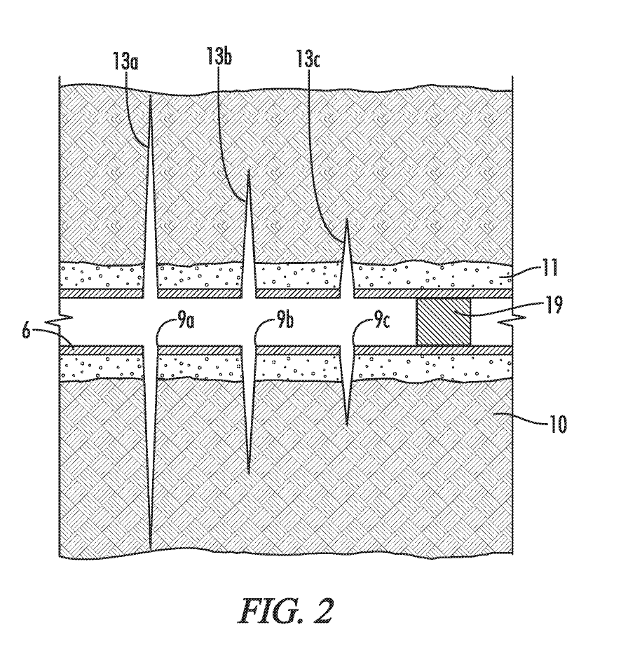

FIG. 1B also has been simplified in another important respect: a single set of perforations 9 and fractures are depicted uphole from each plug 19 and the fractures 13 are all depicted as fairly uniform throughout formation 10. As noted above, however, a single fracturing stage often will entail creating multiple sets of perforations uphole from each plug. Thus, FIG. 2 illustrates schematically three sets of perforations 9 above a plug 19. It will be noted that fracturing in the zone uphole from plug 19 is not uniform. The formation adjacent perforations 9a was more easily fractured, and fractures 13a extend for a greater length away from liner 6. The formation adjacent perforations 9b and 9c, however, was progressively harder. Fractures 13b and 13c extend progressively less far from liner 6.

The novel ball sealers may be used to remedy nonuniform fracturing in a zone. For example, and referencing FIG. 2, a batch of novel sealers (not shown) may be may be pumped into liner 6 along with frac fluids. The sealers will flow preferentially toward perforations 9a as formation 10 offers the least resistance in that region. Fluid flow through perforations 9a will be greater than the flow through perforations 9b and 9c. Thus, the sealers will tend to preferentially lodge against and block flow through perforations 9a. When perforations 9a have been plugged with the sealers, frac fluid will begin to flow preferentially through perforations 9b. Formation 10 in that area is less resistant to fracturing than is the area adjacent perforations 9c, and fractures 13b will tend to be extended further into formation 10. Another batch of sealers then may be pumped into the well to plug perforations 9b. Once perforations 9b have been plugged, fluid will be diverted through perforations 9c and fractures 13c can be extended.

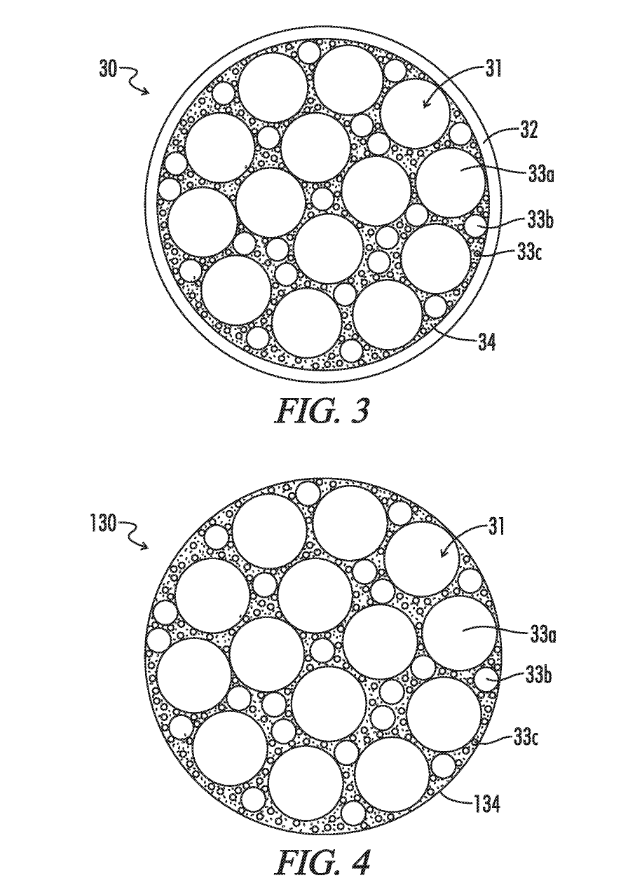

The novel sealers, in simplest terms, preferably comprise an agglomeration of dissolvable particles, collectively referred to as an aggregate. The aggregate may be encapsulated in a dissolvable film, with or without a binder, or it may be dispersed within a dissolvable matrix. For example, a first preferred embodiment 30 of the novel sealers is illustrated schematically in FIG. 3. Sealer 30 generally comprises an aggregate 31 which is encapsulated by a film 32. Aggregate 31 may include particles generally of the same size, but preferably comprises a distribution of different particles 33, such as large particles 33a, medium particles 33b, and small particles 33c.

The size, distribution of sizes, and the composition of the particles, as discussed further below, will be coordinated to provide a sealer that effectively seals perforations, but will not lodge irretrievably therein and will dissolve more quickly. Thus, preferably the size of the particles will be selected to provide a distribution of sizes ranging from large to quite small. The distribution may be substantially continuous. It also may include a number of discrete, nominal sizes. There may be a fairly large number of different nominal sizes, but preferably there will be at least 2 to 4 different sizes.

The larger particles, such as particles 33a, will provide the primary bridge across the perforation to be sealed. Thus, they typically will be at least about 20% of the diameter of the perforations. For typical perforations, that may mean a diameter of from about 1 to about 3 mm. The smaller sizes are intended to fill in the gaps between the large particles and to more effectively plug the perforation. They may have, for example, a diameter of about 30-40% of the diameter of the large particles, or about 20-25% of the diameter of the large particles, such as particles 33b. They may be quite small, however, such as particles 33c, or even smaller, down to 100 microns or less in diameter such as the particles represented by stippling in FIG. 3.

It will be appreciated, of course, that with any collection of particles there is a certain distribution of sizes. At least in the context of commercial processes, it is impossible to produce particles of exactly the same size. The nominal particle sizes may be selected, therefore, to have a tighter or broader distribution of particle sizes. It may be preferable, for example, to provide large particles having a fairly narrow range of particle sizes to ensure that the sealer has sufficient structural integrity. The smaller particles may have a broader distribution of sizes. They may, for example, be screened to have a maximum nominal size.

Moreover, the particles in the figures are depicted as spherical, whereas in practice most particulates have different shapes. Nominal particle sizes also are determined by various methods in the industry, methods which are not always readily disclosed by suppliers. Wire mesh screens may be used to size particles, for example. More commonly, however, particle size analyzers which measure particle size by diffracting laser beams off a sample will be used.

Particles 33 preferably are made of dissolvable compounds, and it will be understood that dissolvable as used herein will encompass not only compounds that are soluble in water, but also those which may be hydrolyzed, disintegrated, or otherwise degraded in the presence of water. Such compounds, therefore, will include water soluble or degradable polymers, such as polylactic acid (PLA). PLA is preferred because it may be modified to provide a fairly wide range of solubility. In its more amorphous form, it is soluble at lower temperatures. It may be produced from racemic mixtures of lactides, however, to yield varying degrees of crystallinity. As the degree of crystallinity increases, PLA becomes less soluble and will dissolve at acceptable rates only at higher temperatures.

Other polymers, however, may be used such as polyglycolic acid and polyvinyl alcohol. Other suitable polymers may include aliphatic polyesters, poly(lactide)s, poly(glycolide)s, poly(e-caprolactone)s, poly(hydroxy ester ether)s, poly(hydroxybutyrate)s, poly(anhydride)s, polycarbonates, poly(ortho ether)s, poly(amino acid)s, poly(ethylene oxide)s, poly(phosphazene)s, polyether esters, polyester amides, polyamides, and copolymers of those polymers. For higher temperature environments, for example, the particles may be made of polyethylene terephthalate. Non-polymeric materials, such as phthalic anhydride, terephthalic anhydride, phthalic acid, terephthalic acid, gilsonite, rock salt, benzoic acid flakes and other materials that dissolve or melt at downhole temperatures, also may be used. The particles also may include additives, both chemical and physical, which will control the dissolution rate of the primary component of the particle, such a magnesium hydroxide and other alkali metal hydroxides.

While dissolvable particles are preferred, the aggregate may include non-dissolvable particles as well. In general, dissolvable particles will constitute the majority of the aggregate, and especially the majority of the smaller particles. Non-dissolvable particles may be included so long as their presence does not sustain the integrity of the aggregate beyond the desired time frame. Non-dissolvable particles also may be incorporated to provide additional properties, such as increased strength, or to control the specific gravity and the buoyancy of the sealers.

For example, the aggregate may include glass microspheres to make the sealer denser than the frac fluid (a “sinker”) or lighter than the frac fluid (a “floater”). Control over the buoyancy may be particularly useful in the context of horizontal extensions of a well. Sinkers will tend to accumulate along the “bottom” of a horizontal liner. They will be less likely to seal perforations on the “top” of the liner. The opposite may be true for floaters. Neutral buoyancy sealers, or a combination of sinkers and floaters may be preferable for such wells.

Film 32 also preferably is dissolvable and preferably is made of a water soluble or degradable thermoplastic polymer, such as a polyester. Polyamides and polyglycolic acid also may be used. When packaged within film 32, aggregate 31 in sealer 30 will be somewhat deformable under pressure. That will enable sealers 30 to form a good seal against a perforation, even if the perforation is irregular or otherwise does not present a good sealing surface.

It may be preferable, in order to facilitate packaging of the aggregate in a film, that the particles be agglomerated by a polymer matrix, such as matrix 34 of sealer 30. (Depicted in FIG. 3 as the void between particles 33.) That may be particularly helpful when aggregate 31 includes very small particles, such as the particles illustrated as stippling in matrix 34. The matrix preferably is a water-soluble binder. Preferably, it will provide a relatively viscous binder that will allow some deformation of the aggregate within the sealer under pressures typically experienced in service. Thus, binders other than polymers, such as waxes and other materials that dissolve or melt at downhole temperatures, may be used.

A second preferred embodiment 130 of the novel sealers is illustrated in FIG. 4. As may be seen therein, sealer 130 is similar to sealer 30. It comprises an aggregate 131 comprising a distribution of different particles 33 including large particles 33a, medium particles 33b, and small particles 33c. In contrast to sealer 30, however, sealer 130 does not have an encapsulating film. Instead, the integrity of sealer 130 is provided by a highly viscous or solid matrix 134. Matrix 134 preferably is made of dissolvable material, such as polyvinyl alcohols, polyethylene oxides, polyacrylates, polymethacrylates, polyvinylidene chloride, and copolymers thereof.

Dissolvable sealers are known and have been fabricated from the same materials from which the aggregate particles in the novel sealers may be made. Conventional sealers, however, consist of a single relatively large ball (or other particle shape), typically having at least one dimension a bit larger than the perforations to be sealed. Thus, they may only dissolve or degrade over a relatively long period of time or only at relatively high temperatures.

In contrast, the particles in the novel sealers are relatively small and have dimensions substantially smaller than the perforations. As compared to an integral sealer of the same size and approximate mass, the aggregate will have much greater surface area exposed to fluids. Thus, even when made of identical materials, the aggregate will degrade more quickly under the same conditions.

Ideally, a sealer will stay intact no longer than necessary to complete the fracturing operation, but that time may vary. In addition, well conditions, primarily temperature, will dramatically affect the dissolution rates of polymers. The size and configuration of conventional integral sealers, however, is largely dependent on the size and configuration of the perforations. Thus, the service life of conventional dissolvable sealers in large part can only be varied by varying the material from which the sealer is fabricated.

The composition of the aggregate particles in the novel sealers also may be varied to provide an appropriate service life for particular well conditions. In contrast to conventional dissolvable sealers, however, the size and size distribution of particles in the aggregate may be varied considerably to provide greater or lesser surface area for a given mass. Thus, the service life of the aggregate may be varied more easily to ensure that it stays intact for no longer than necessary regardless of well conditions.

It also will be appreciated that the service life of the sealers will depend primarily on the size, distribution, and composition of the smaller particles. As noted, the larger particles serve primarily as a bridge and a framework within which the smaller particles are confined. At the same time, the smaller particles serve to restrict or clog flow through the sealer, thus maintaining the integrity of the framework established by the larger particles. As the smaller particles begin to dissolve, therefore, flow will be established through the large-particle framework. The large particles will be dislodged easily from the perforation even if they themselves have not substantially degraded.

The service life of the film for given well conditions will depend largely on the composition and thickness of the film. The film, however, does not necessarily have to remain intact for the duration of the fracturing operation. Typically, the film in the novel sealers may be selected such that it remains intact for a relatively short period of time, only long enough for the sealers to be pumped into the liner and reach the perforated zone. That may mean times as short as a half hour or less. Likewise, a binder or matrix, if present, can be selected to degrade relatively quickly. Once the aggregate has been delivered to the perforation, hydraulic pressure within the liner will ensure that it remains there. At the same time, even if the hydraulic pressure causes it to stick in the perforation, the aggregate will dissolve relatively quickly after fracturing is completed.

It will be noted that sealers 30 and 130 have been illustrated as substantially spherical, as are most ball sealers. Though they may be deformable as discussed above, that generally will be the preferred initial shape of the sealers as they are deployed. The novel sealers, however, may have regular geometries approaching a spherical shape such as slightly eccentric ellipsoids, high order regular polyhedrons, or dimpled or pimpled surfaces. It also will be appreciated that sealers with different geometries, regular or irregular, such as polyhedrons, parallelepipeds, prisms, cylinders, pyramids, cones, ellipsoids, may be adaptable for use with particular perforations. In the context of this application, therefore, “sealers” will be understood to encompass spherical sealers and sealers having other geometries which are adapted to seat on and substantially shut off flow through an opening in a well liner.

Similarly, the exemplified sealers are particularly useful in fracturing a formation and have been exemplified in that context, but they may be used advantageously in other processes for stimulating production from a well. For example, an aqueous acid such as hydrochloric acid may be injected into a formation to clean up the formation and ultimately increase the flow of hydrocarbons into a well. In other cases, “stimulation” wells may be drilled in the vicinity of a “production” well. Water or other fluids then would be injected into the formation through the stimulation wells to drive hydrocarbons toward the production well. The novel sealers may be used in such stimulation processes and others where it may be desirable to create and control fluid flow in defined zones through a well bore. Though fracturing a well bore is a common and important stimulation process, the invention is not limited thereto.

Ball sealers have been used to shut off flow through ports in liner valves. The novel sealers also may be used in such operations. Moreover, older, existing wells may require stimulation. It may be more economical to use the novel sealers to plug openings in the well instead of installing a series of stimulation plugs to isolate the openings.

The figures also depict a perforated liner, and more specifically, a production liner which may be used to stimulate and produce hydrocarbons from the well. A “liner,” however, can have a fairly specific meaning within the industry, as do “casing” and “tubing.” In its narrow sense, a “casing” is generally considered to be a relatively large tubular conduit, usually greater than 4.5″ in diameter, that extends into a well from the surface. A “liner” is generally considered to be a relatively large tubular conduit that does not extend from the surface of the well, and instead is supported within an existing casing or another liner. It is, in essence, a “casing” that does not extend from the surface. “Tubing” refers to a smaller tubular conduit, usually less than 4.5″ in diameter. The novel ball sealers and methods, however, are not limited in their application to liners as that term may be understood in its narrow sense. They may be used to advantage in liners, casings, tubing, and other tubular conduits or “tubulars” as are commonly employed in oil and gas wells.

### EXAMPLES

The invention and its advantages may be further understood by reference to the following example. It will be appreciated, however, that the invention is not limited thereto.

### Example 1

A 1.5 inch ball sealer was fabricated for proof of concept. The aggregate was made from polylactic acid (PLA) products sold commercially as diverting material. The large particles were PLA beads sold as size 6-8 mesh (2.38-3.36 mm). The small particles were a 20 mesh and below (≤0.841 mm) PLA powder. The PLA beads constituted approximately 20 wt % of the aggregate with the PLA powder constituting the balance. The aggregate was encapsulated within two polyvinyl alcohol half-shells that were fitted together.

The test ball sealer was placed on a ⅜ inch opening in a fluid loss apparatus. The apparatus was filled with water at room temperature and a pressure of 1,800 psi was applied. The ball sealer held pressure for a period of 2.5 hours, after which time the polyvinyl alcohol shell dissolved allowing flow through the aggregate.

It will be noted that the test ball sealer was somewhat larger than ball sealers used commercially. Nevertheless, the testing shows that using a distribution of particle sizes can significantly shorten the service life of a ball sealer.

While this invention has been disclosed and discussed primarily in terms of specific embodiments thereof, it is not intended to be limited thereto. Other modifications and embodiments will be apparent to the worker in the art.

What is claimed is:

1. A sealer for deploying into a well, said sealer comprising an aggregate of dissolvable particles.

2. The sealer of claim 1, wherein said dissolvable particles have a distribution of particle sizes.

3. The sealer of claim 2, wherein said dissolvable particles comprise particles of a first particle size and a distribution of second, smaller particle sizes.

4. The sealer of claim 2, wherein said dissolvable particles comprise at least three different sizes.

5. The sealer of claim 2, wherein said particle sizes include large particles having a diameter of at least about 20% of a target liner opening size.

6. The sealer of claim 2, wherein said particle sizes includes large particles having a diameter from about 1 to about 3 mm in diameter.

7. The sealer of claim 2, wherein said particles comprise smaller particles having a diameter of from about 30 to 40% of the diameter of said large particles.

8. The sealer of claim 2, wherein said particles comprise a distribution of smaller particles having a diameter of from about 30 to 40% of said large particles or less.

9. The sealer of claim 1, wherein said particles are composed of a dissolvable polymer.

10. The sealer of claim 1, wherein said aggregate comprises a matrix agglomerating said dissolvable particles.

11. The sealer of claim 10, wherein said matrix is dissolvable.

12. The sealer of claim 11, wherein said matrix is a dissolvable polymer.

13. The sealer of claim 10, wherein said matrix allows for deformation of said aggregate.

14. The sealer of claim 10, wherein said matrix provides structural integrity for said aggregate.

15. The sealer of claim 1, wherein said aggregate is encapsulated in a dissolvable film.

16. The sealer of claim 15, wherein said film is composed of a dissolvable polymer.

17. A method of selectively diverting well fluids through a plurality of openings in a liner during a stimulation operation; said method comprising:
(a) pumping fluid into said liner;
(b) deploying a batch of sealers into said fluid sufficient to plug a subset of said liner openings;
(c) flowing said sealers into said subset of liner openings, said sealers plugging said subset of openings and diverting flow through unplugged openings in said liner;
(d) wherein said sealers comprise an aggregate of dissolvable particles.

18. The method of claim 17, wherein said dissolvable particles have a distribution of particle sizes.

19. The method of claim 18, wherein said dissolvable particles comprise particles of a first particle size and a distribution of second, smaller particle sizes.

20. The method of claim 18, wherein said dissolvable particles comprise at least three different sizes.
